(19) United States
(12) Patent Application Publication
(10) Pub. No.: US 2005/0274453 A1
(43) Pub. Date: Dec. 15, 2005

(54) Adhesive strip applicator

(76) Inventor: Bardia A. Anvar, Encino, CA (US)

Correspondence Address: Rachele Wittwer;IRELL & MANELLA LLP, Suite 900, 1800 Avenue of the Stars, Los Angeles, CA, 90067, US

(21) Appl. No.: 10/866,001

(22) Filed: Jun. 10, 2004

(51) Int. Cl. B44C 1/00

(52) U.S. Cl. 156/247; 156/540; 156/579

(57) ABSTRACT

A device and method for applying adhesive strips or bandages of various sizes and configurations to a surgical wound in a facile manner.

### BACKGROUND OF THE INVENTION

1. Field of the Invention

This invention relates to adhesive strip applicators, and in particular to applicators for applying adhesive strips used to close wound-like openings in planar surfaces, such as surgical wounds.

2. Description of the Related Art

Many types of adhesive strips are known for use in protecting wound-like openings in planar surfaces including the common adhesive bandage, such as bandaid bandages and surgical adhesive strips, including Steri-Strip® adhesive strips made by the 3M Company. Other adhesive strips are used for repairing or protecting other surfaces, such as repairing clothing or boat sails. Conventional adhesive strips are applied by hand or, in some circumstances, from a continuous roll of adhesive such as packaging tape.

What is needed is a technique for applying adhesive strips which is more convenient, flexible and repeatable than applying such strips by hand.

### SUMMARY OF THE INVENTION

In a first aspect, a medical appliance for dressing wounds has one or more adhesive strips adapted to be applied to a wound area as a dressing or bandage a backing plate on which the adhesive strip is adhesively mounted. The strength of adhesive between the adhesive strip and the backing plate is sufficiently less than the strength of adhesive between the adhesive strip and the wound area, when the strip(s) are adhered to the wound area, so that the backing plate may be removed after the strip(s) are adhered to the wound area. A plurality of adhesive strips may be mounted to the backing plate in a pattern so that the strips may be adhered to the wound area in a predetermined pattern. A handle may be affixed to the backing plate for applying the adhesive strip(s) to the wound area by moving the mounting surface into contact with the wound area and for removing the mounting surface from the adhesive strips when the strips are adhered to the wound area.

A mounting surface on the backing plate curved about an axis, and a handle, may be affixed to the backing plate, for applying the adhesive strip to the wound area by moving the mounting surface into contact with the wound area while causing the baking plate to rotate and press the adhesive strip(s) against the wound area. The adhesive strip(s) may be adhered to the mounting surface in parallel with, or transverse to, the axis and may be arranged in a pattern in order to produce a desired pattern of strips applied to the wound area.

The backing plate may include a generally cylindrical mounting surface mounted for rotation about the axis and an axle may be provided supporting the backing plate for rotation about the axis. Sub-surfaces of the mounting surface may be longitudinally separable along the axis to hold the strip(s) in tension so that they to help maintain closure of the wound when adhered thereto.

The handle may have a single arm supporting one end of the axle and on offset portion between the arm and a hand grip to cause pressure applied by the hand grip to be applied evenly across the wound. Alternately, the handle may have a pair of arms each supporting one end of the axle. Alternately, the handle may form an axis supporting the backing plate in the manner of a rolling pin grippable at both ends for rotation of the mounting surface about the axis.

A compressible layer mounted between the backing plate and the mounting surface may be generally cylindrical or with a convex or concave surface or one having one cross sectional end substantially larger than another cross sectional end.

In another aspect, a method for adhering strip(s) to a wound area includes adhesively applying a first surface of an adhesive strip to a backing plate with a first strength of adhesion, adhesively applying a second surface of the adhesive strip to the wound area with a second strength of adhesion greater than the first strength of adhesion, and removing the backing plate from the wound area, leaving the adhesive strips adhered to the wound area. The adhesive strips may produce a desired pattern of strips adhesively applied to the wound area when the backing plate is removed. The backing plate may be rolled or rotated about an axis while the second surfaces are in contact with the wound area. The adhesive strips may be mounted to the backing plate in parallel with, or transverse to, the axis.

The backing plate is generally cylindrical in shape, may be mounted for rotation about the axis and may be mounted on an axle supported in a handle. Portions of the backing plate may be mounted along the axis with each of the ends of the adhesive strips adhered to a different portion of the backing plate. The portions may then be separated when the adhesive strips are applied to the wound area so that the adhesive strips are in tension after being adhered to the wound area to help maintain closure of the wound. One end of the backing plate may be supported by one end of the axle at one end of an arm and separated from a hand grip on the handle by an offset portion to cause pressure applied by the hand grip to be applied evenly across the wound area. Alternately, each end of the axle may be supported at one end of a pair of arms attached to a handle.

A compressible layer may be placed between the backing plate and the adhesive strips to compensate for uneven features of the surface of the wound area and the mounting surface may have a generally cylindrical, concave or convex shape or have one cross sectional end substantially larger than the other cross sectional end.

In a still further aspect, a medical appliance for applying adhesive strips to the wound area may include adhesive strips adapted to be applied to the wound area, and backing plate means on which the adhesive strips are adhesively mounted with a strength of adhesive less than the strength of adhesive between the adhesive strip and the wound area (when the strips are adhered to the wound area) for adhering the strips to the wound area in a predetermined pattern. A handle means may be affixed to the backing plate for adhering the adhesive strips to the wound area by moving the backing plate into contact with the wound area, and then for removing the backing plate from the adhesive strips. The backing plate may be mounted for rotation to the handle means about an axis to press the adhesive strips against the wound area. The adhesive strips may be adhered to the backing plate parallel with, or transverse to, the axis. The backing plate may have a generally cylindrical mounting surface to which the strips are adhered and may include means for applying tension to the adhesive strips before the strips are applied to the wound area to cause the adhesive strips to be in tension after being adhered to the wound area to help maintain closure of the wound. The handle means may include an offset portion means for applying pressure from the handle means evenly across the wound.

A compressible layer means may be mounted between the backing plate and the mounting surface and the mounting surface may have a generally cylindrical, convex or concave surface or one having one cross sectional end substantially larger than the other cross sectional end for applying the strips evenly to a wound area having a non-flat surface.

### BRIEF DESCRIPTION OF THE DRAWINGS

FIG. 1 is a perspective view of a strip applicator.

FIG. 2 is a front view of a field of strips.

FIG. 3 is a perspective view of a protective layer overlying a cylindrical backing plate.

FIG. 4 is a perspective view of a strip applicator with an offset handle.

FIG. 5 is a perspective view of a strip applicator with a flat backing plate.

FIG. 6 is an exaggerated side view of the applicator of FIG. 5.

FIG. 7 is a bottom view of the embodiment of the applicator of FIGS. 5 and 6.

FIG. 8 is an isometric view of an applicator in the general form of an ink blotter.

FIG. 9 is an exploded view of an applicator having a cylindrical backing plate mounted between arms of a handle.

FIG. 10 depicts the applicator of FIG. 8 with a larger backing plate.

FIG. 11 is an isometric view of an applicator with a strip mounted transverse to the axis of rotation of the backing plate.

FIG. 12 is an isometric view of an applicator generally in the form of a rolling pin.

FIG. 13 is an isometric view of an applicator with a backing plate having the cross section of one end larger than the cross section of the other end.

FIG. 14 is an isometric view of an applicator having separable portions of the backing plate in a storage configuration.

FIG. 15 is a isometric view of the backing plate of the applicator of FIG. 14 during application of the strip(s) to the wound.

FIG. 16 is a front view of a backing plate having a convex cylindrical shape.

FIG. 17 is a front view of a backing plate having a concave cylindrical shape.

FIG. 18 is a partial cross sectional view of an applicator having a single layer of strips.

FIG. 19 is a partial cross sectional view of an applicator having multiple layers of strips.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The primary purpose of medical operation is to correct a deficit in anatomy or physiology in a patient in the safest and most effective fashion possible. Most procedures require a surgical incision in order to advance to a deeper anatomic defect. Once the defect is corrected, it is just as important to close the incision with the least amount of trauma to the tissue and in the most sterile fashion possible in order to ensure that an infection will not ensue. In order to close a surgical incision, a number of factors must be met. First, the wound edges must be approximated, aligned and then kept together. In most instances the superficial wound edges are brought together by running a subcuticular stitch.

In order to reinforce the approximation of the stitch, it is then usual to manually apply an adhesive bandage or strip, such as Steri-Strip® closure tape. However, the application of the tape to a wound is cumbersome. Steri-Strip® tapes are traditionally used as a precautionary adhesive in the event that stitches, or on occasion staples, fail to hold wound edges together. The manufacturer recommends Steri-Strip® to be used as a primary wound closure only for low tension wounds. In surgical procedures involving deep high tension wounds however, sutures and/or staples are used as the primary closure followed by a layer of surgical adhesive or tape strips as reinforcement. Surgical adhesive strips are conventionally applied with a sterile gloved hand to the wound edge in successive fashion perpendicular to the wound until the wound is covered in its entirety.

The area around the wound is first dressed with a sterile antiseptic adhesive, such as mastisol or 15 benzoine ointment, to facilitate both adhesion and sterilization. The surgical adhesive strip is then cut to size, if necessary, before it is applied to the wound. From the gloved hand, the surgical adhesive strip is applied to one side of the wound and then it is laid down to the other side of the wound and released to reinforce the wound edge. It may take as many as 40, to as little as 1, surgical adhesive strips to properly cover the wound, depending on the length of the wound. Once this process is finished the wound site is typically covered with sterile dressing for a minimum of 2 days. The first 48 postoperative hours are crucial in wound healing. During this early period 10% of the granulation tissue is formed. Therefore it is important at this time for the surgical adhesive strips to maintain their adhesion and reinforcement. Patients are then often instructed to shower regularly and allow the adhesive strips to fall off naturally in the shower.

Surgical adhesive strip are conventionally manually applied to the wounds, one by one, in successive fashion by the surgeon's or assistant's gloved hand. The application of the surgical adhesive strip can become an arduous task because the strip's adhesive easily sticks to surgical gloves, thus making a simple but necessary procedure a longer and more frustrating task than necessary. Moreover, another challenge of this procedure is the cutting of the closure tape to fit varying size wounds. On a substantial number of occasions, doctors waste precious operating time adjusting with the adhesion strips.

Referring now to FIG. 1, a first embodiment is disclosed, particularly for use in operating room environs, in which adhesive strip applicator 10 may be used by a physician having sterile rubber gloves on his hands in order to maintain a sterile field.

In particular, adhesive strip applicator 10 may be used in a surgical or other medical environment to apply one or more adhesive strips 14 from backing roll 12 onto a wound. Backing roll 12 may include a plurality of spaced adhesive strips or bandages 14 in releasable fashion for transfer from backing roll 12 to a discrete area for closing a wound or the like. Adhesive strip applicator 10 may also be used to apply one or more strips 14 to dress already stitched and closed wounds.

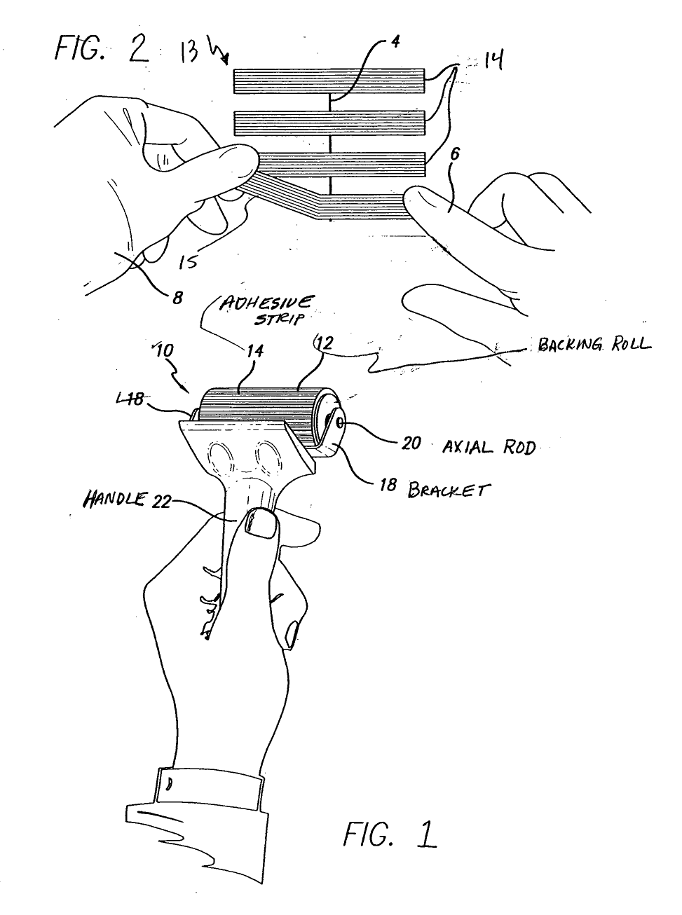

Adhesive strip applicator 10 may include handle 22, preferrably including a handgrip, for comfortable grasping by the surgeon. Handle 22 may support bracket 18 which supports backing roll 12 on axial rod 20 for convenient rotation. The pressure applied to the hand grip is caused to be applied evenly across the wound area. For use in medical environments, adhesive strip applicator 10 should be completely sterile. Adhesive strip applicator 10 may be packaged in sterile packaging, not shown, which is removed only in the operating room. Before use, a cover or non-stick layer, such as cover layer 30 shown in FIG. 2 may be removed to expose the outer surface of backing roll 12 on which a plurality of adhesive tape strips 14 are mounted, preferably on a mounting surface on the backing roll. A surgeon would position adhesive strip applicator 10 to place one of the strips 14 at one end of the wound. For use in applying strips to a linear wound, it may be desirable to apply strips 14 transverse to the wound. Strips 14 may be mounted on backing roller 12 parallel to the axis of rotation of backing roll 12, that is parallel with axial rod 20, so the surgeon can properly align the strips 14 to be applied to the wound by aligning handle 22 to be parallel with the wound and moving applicator 10 along the wound while causing the backing plate to rotate and press the adhesive strip(s) against the wound area. When an appropriate number of strips have been applied to the wound, the surgeon may raise applicator 10 from the wound site thus ending the dressing procedure.

Referring now to FIG. 2, a field 13 of strips 14 applied by applicator 10 may be applied to linear wound 14 in parallel with each other, each generally perpendicular to linear wound 14. For comparison with conventional techniques, strip 15 at the end of field 13 is shown being manually applied by surgeon 8 to the same linear wound 4. It is important to note, that in addition to the advantages of quickly applying a predetermined field of strips 14 to the wound in a predetermined manner, the use of applicator 10 avoids contact between the surgeon's gloved hands and the individual adhesive strips, such as strip 15, minimizing the difficulties that often result from partial adhesion between the strips and the surgeon's gloves. That is, in addition to avoiding the time consuming and labor intensive process required to manually apply a field of strips in a predetermined pattern, the use of applicator 10 reduces the common occurrence of the surgeon having to replace, realign or otherwise take the additional time to correct problems which result from even partial adhesive contact between strips 14 and the surgeon's gloves.

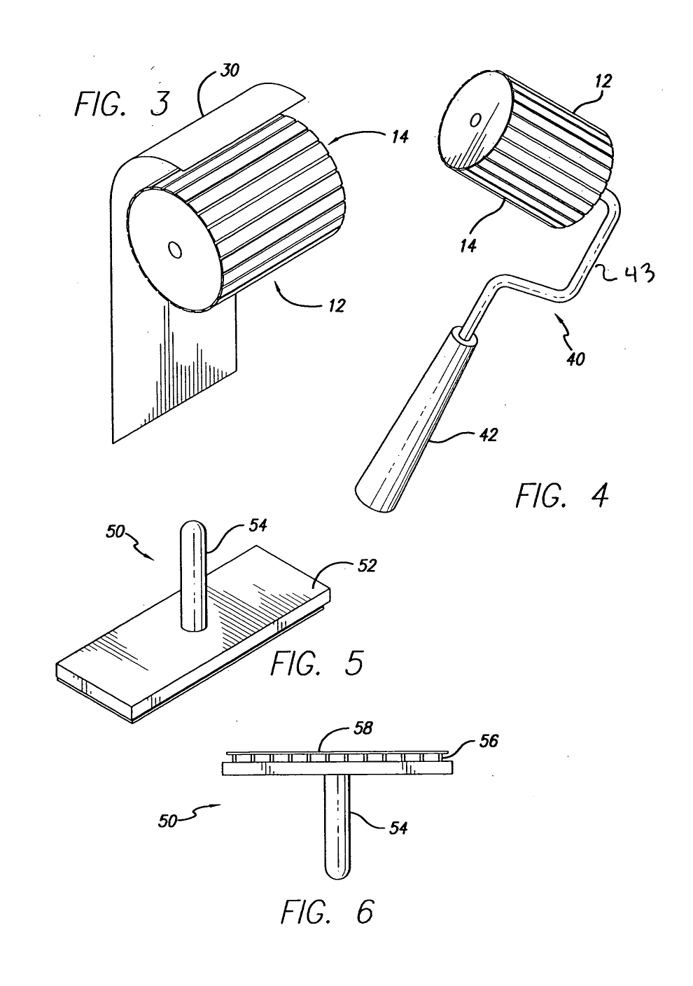

Referring now to FIG. 4, in another embodiment, adhesive strip applicator 40 may be configured with handle 42 including an offset elongated section 43 serving directly as the axis for rotation backing roll 12.

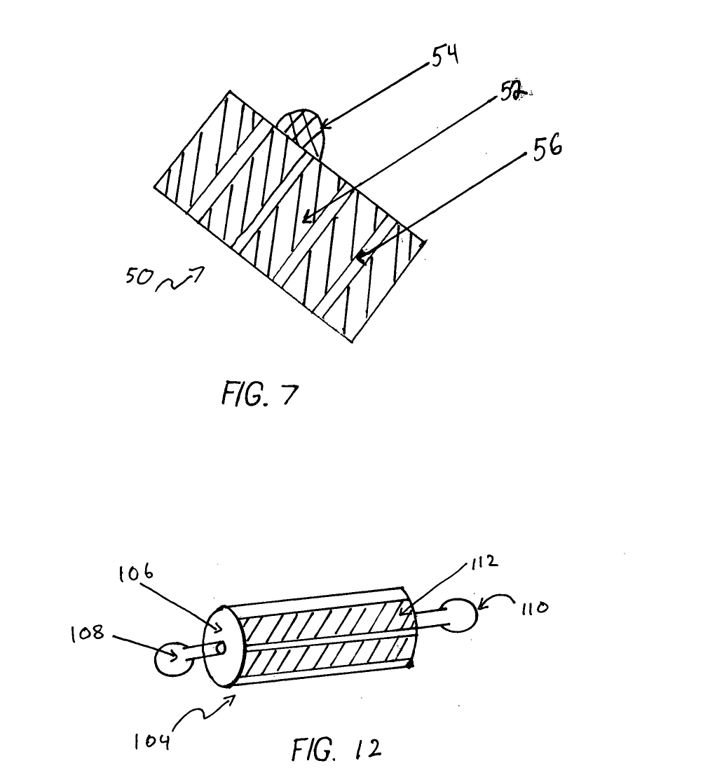

Referring now to FIGS. 5, 6 and 7, in a still further embodiment, adhesive applicator 50 may include a flat platen member 52 on which are releasably mounted a series of adhesive strips 56 protected by a non-stick overlay cover, such as paper layer 58, which is removed prior to application of applicator 50 to a wound or the like. Applicator 50 may include handle 54. In use, the surgeon may grasp handle 54 to apply flat platen member 52 parallel to the surface surrounding the wound area in the manner of applying a stamp to that surface.

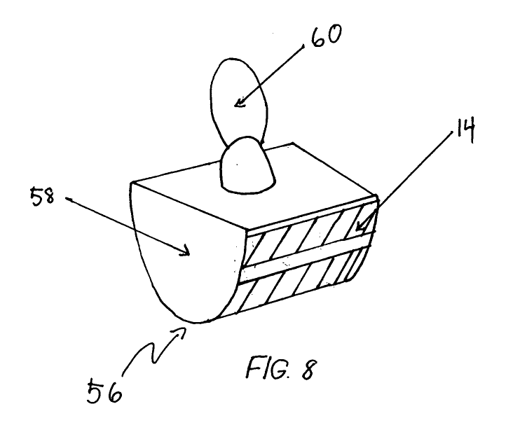

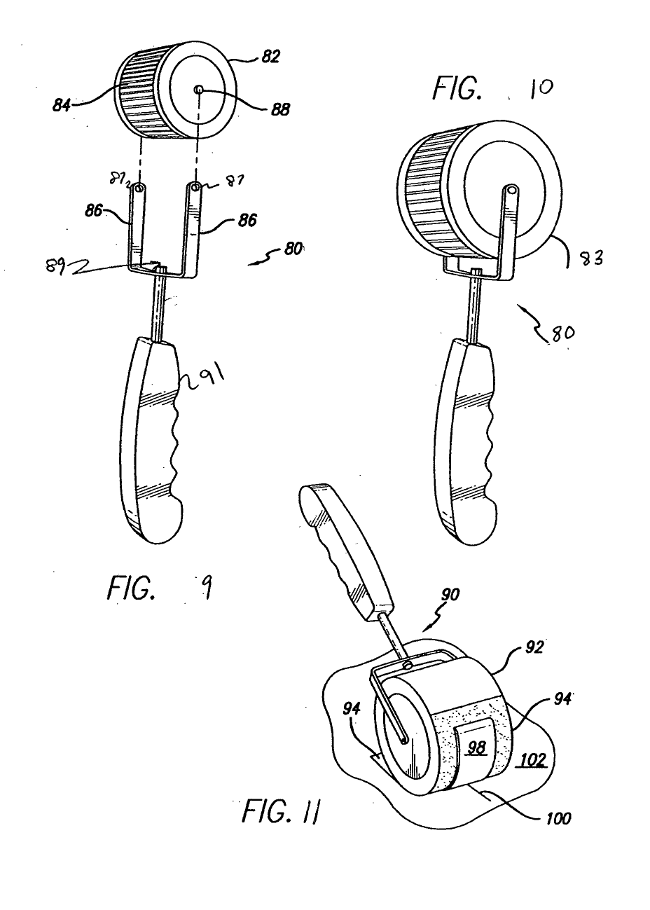

Referring now to FIG. 8, in a still further embodiment, adhesive applicator 56 may include curved platen or backing roller 58 on the outer surface of which are releasably positioned a plurality of adhesive strips 14. Applicator 56 may also include handle 60. In use, the surgeon may grasp handle 60 and apply curved platen roller 58 to the surface surrounding the wound in the manner of applying an old fashioned ink blotter to the surface of a sheet of paper on which the ink is wet.

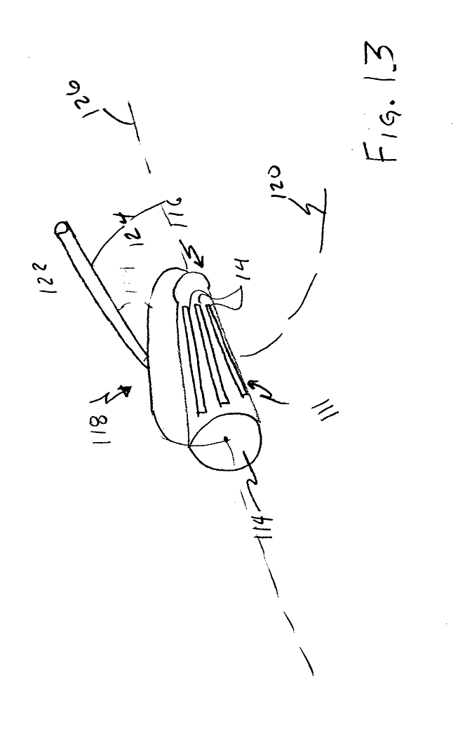

Referring to FIGS. 9 and 10, adhesive applicator 80 includes easily replaceable backing roll 82 on the outer surface of which are positioned a series of spaced adhesive strips 84 for placement onto a wound area. Opposed ear brackets 86, of handle 91, may be of spring steel to be spread apart to easily accept axial rod 88 of roll 82 in releasable fashion. As indicated in FIG. 8, the radius of backing roll 82 is substantially smaller than the distance from bearings 87 of opposed ear brackets 86 in which the ends of axial rod 88 are supported, to nearest point 89 of handle 91. This permits a substantially larger backing roll, such as backing roll 83 shown in FIG. 9, to be interchangeably used in adhesive applicator 80. In this manner, a single applicator, with two or more interchangeable backing rolls of different sizes, may be used to provide fields of different numbers, sizes, orientation or numbers of strips 84 for use in different applications.

Referring now to FIG. 11, in a still further embodiment, adhesive applicator 90 rotatably supports backing roll 92 on which an adhesive strip 94 is positioned with its longest dimension transverse to the axis of rotation of backing roll 92, rather than parallel with the axis as shown above. In this manner, a longer strip may be mounted on a backing roll than would be possible if the strip were oriented to be parallel to the axis of rotation of the backing roll as shown in the other figures. As shown in FIG. 11, adhesive strip 94 may include gauze or bandage area 98 to be applied to wound area 100 of body surface 102.

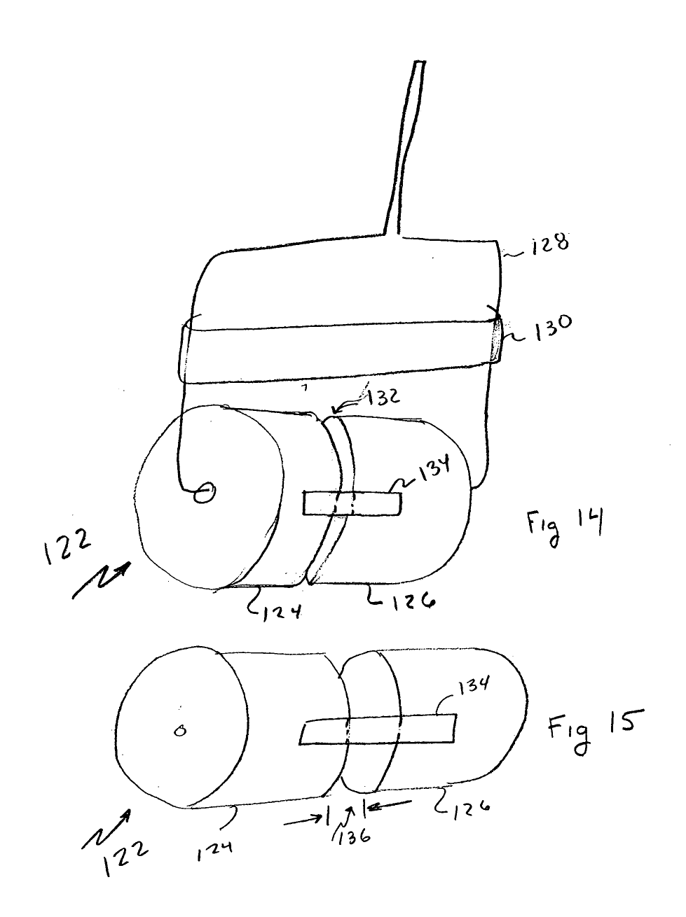

Referring now to FIG. 12, in a further embodiment, adhesive applicator 104 may be in the form of a cylindrical backing roller, such as roller 106, mounted for rotation about a common axis between a pair of handles, such as handles 108 and 110, which may form all or a portion of an axle rod extending through roller 106. In operation, adhesive strips 112 may be releasably mounted to the outside surface of roller 106 and may be oriented with the long dimension of the strips parallel to the common axis permitting the use of relatively longer strips than would be usable if oriented transverse to the axis in this embodiment. Further, the surgeon may advantageously, using both hands on handles 108 and 110, cause greater pressure to be applied by roller 106 to the surface area of the skin around the wound.

Referring now to FIG. 13, the backing roller need not be in the form of a portion of a right circular cylinder. A backing roller in the form of a truncated right circular cone, such as backing roller 111, in which first roller face 114 may be of a substantially different size, for example larger, than second roller face 116, may be advantageously used in applicator 118 to apply a curved field of strips 14 along a non-linear wound, such as would 120. As further aid to the convenient application of a curved field of strips, strips 14 may be releasably mounted to roller 112 so that the axes of each of the strips 14 is parallel to the axis of rotation of roller 112, but not parallel to each other. As shown in the figure, the ends of strips 14 nearest smaller roller face 116 may be closer to each other than the ends of the strips 14 nearest the larger roller face 114. With this orientation, strips 14 may be applied to a non-linear wound so that each strip 14 is relatively transverse to the portion of the wound to which it has been applied. Still further, handle 122 may be mounted to applicator 118 at an angle different than 90° from the axis of rotation of backing roller 112, shown as angle 124. The combination of the difference in sizes of roller faces 116 and 114, and the offset of angle 124 from 90°, may be advantageously selected to make it easier for the surgeon to neatly apply the field of strips 14 relative to non-linear wound 120.

Referring now to FIGS. 14 and 15, in a still further embodiment, adhesive applicator 122 is configured to take advantage of the elasticity available in some adhesive strips to apply further closing pressure to the wound. Applicator 122 includes a pair of backing rollers 124 and 126 mounted for rotation on handle and frame assembly 128. Alternately, rollers 124 and 126 may be a pair of sub-surfaces of a mounting surface on the backing roller. The pair of backing rollers or sub-surfaces are longitudinally separable along the mounting axis when applied to said wound area. Clamp 130 may be used to maintain handle and frame assembly 122 in a slight compression so that rollers 124 and 126 are held in close proximity to each other before use with either no gap there between or only a small gap there between such as gap 132. Strip 134 is illustrated as one of a plurality of strips that are releasably mounted to the outer surfaces of rollers 124 and 126 with little or no tension along the long dimension of strip 134. Before use, clamp 130 may be released so that rollers 124 and 126, together with a plurality of strips such as strip 134 releasably mounted across rollers 124 and 126 (and gap 132 if present), may be inserted into handle and frame assembly 128. Clamp 130 may then be reapplied, preventing rollers 124 and 126 from further separating and preventing the application of any further tension to strip 134.

Referring now also to FIG. 15, in use, the surgeon after removing any sterile packaging protecting applicator 122, may release clamp 130 so that handle and frame assembly 128 expands creating gap 136 between backing rollers 124 and 126. Gap 136 is larger than gap 132, if present, and is large enough to create a substantial tension in strip 134, elastically stretching it. Thereafter, when applicator 122 is used to apply a field of strips across a wound, each strip will be in a stretched condition when applied to the wound, causes the adhesive strips to be in tension after being adhered to the wound area to help maintain closure of the wound. Preferably, the elastic forces in strip 134 tending to return the strip to its unstretched condition are applied to the wound to aid in closing the wound and holding it closed during healing.

Referring now to FIG. 16, the backing rollers need not be portions of a right circular cylinder or truncated cone. Backing roller 138, mounted for rotation about axis 140, is shown in FIG. 16 having a convex outer surface 142 on which are mounted a plurality of strips 144. Convex backing roller 138 may be useful in particular situations, for example, when the wound to be dressed is wholly or partly in a generally concave surface shape such as along the neck or under the chin of a patient. After applying a field of strips using convex backing roller 138, it may be desirable to smooth down the ends of the strips applied in order to provide adequate adherence between the strips and the skin.

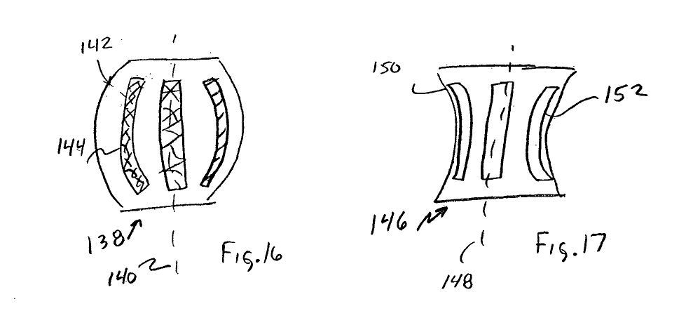

Referring now to FIG. 17, concave backing roller 146 mounted for rotation about axis 148 is shown in having a concave outer surface 150 on which are mounted a plurality of strips 152. Concave backing roller 146 may be useful in particular situations, for example, when the wound to be dressed is wholly or partially in a generally convex surface shape such as along the shin of a patient. After applying a field of strips using concave backing roller 146, it may be desirable to smooth down the ends of the strips applied in order to provide adequate adherence between the strips and the skin.

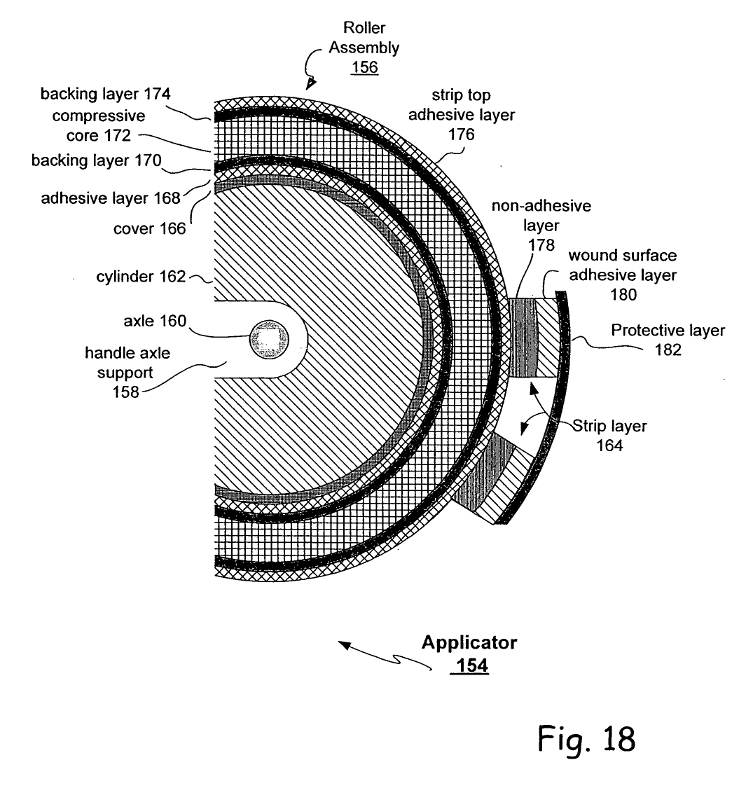

Referring now to FIG. 18, a portion of applicator 154 is shown in which a portion of roller assembly 156 is illustrated including frame or handle axle support 158 and axle 160. The portion of roller assembly 156 is shown in an exaggerated cross sectional view for ease in disclosing the various layers that may be present. At the center of roller assembly 156, mounted for rotation about axle 160, is cylinder 162 which may be hollow or solid and may conveniently be made from a plastic or similar material so that cylinder 162 is strong enough to resist substantial deformation from the forces applied by a surgeon or other user while applying a field of adhesive strips, one of which is indicated as adhesive strip 164, to a surface surrounding a wound. Cylinder 162 may advantageously be surrounded by cover 166 of a relatively more flexible material such as hard rubber or the like. If used, cover 166 serves to reduce the rigidity of roller assembly 156 in order to conform somewhat to the shape of the skin or other surface to which the field of strips is applied. The next series of layers form a compressible layer, shown as layers 168, 170, 172, 174 and 176, which serves to permit roller assembly 156 to more closely conform to the surface surrounding the wound and to compensate for any uneven features of the surface of the wound area.

Compressible core layer 172 may conveniently be formed of compressible foam rubber or a similar material capable of being compressed on the order of 50% or more of its thickness. The actual compressibility of compressible core layer may be selected in accordance with the compressibility of the surface surrounding the wound to cause the field of strips to be applied accurately without subjecting the wound area to undue pressure. As a simple example, compressible core layer 172 in an applicator used to apply a field of strips to a wound on the surface of an eyelid may be selected to be substantially more compressible than a compressible core layer used in an applicator used to apply a field of strips to a wound on a less compressible surface such as the surface of the abdomen. Further, the effect of any compressibility of cover 166, if used, may also have an effect on the compressibility required of compressible core layer 172 in order to provide the desired resultant total compressibility of roller assembly 156 for its intended use. Similarly, if strips are to be applied to a different surface, such as the surface of a sailboat sail to mend a tear in the sail material, the compressible layer may not be required and the flexibility of cover 166 may be sufficient to cushion the surface to be dressed or mended. In some situations, it may also be desirable to eliminate cover 166 to minimize the flexibility of roller assembly 156.

If compressible core layer 172 is utilized, it may conveniently be applied by any conventional means such as an adhesive layer not shown to backing material 170 which may conveniently be a paper or plastic. Backing material 170 may be secured to cover 166 if present, or cylinder 162 if cover 166 is not present, by adhesive layer 168. The outer surface of compressible core layer 172 is used to support strip top adhesive layer 176 by any conventional means, such as by applying strip top adhesive layer 176 to a backing layer such as layer 174 which itself may be secured to compressible core layer 172 by any suitable means such as another adhesive layer, not shown.

Strip top adhesive layer 176 is used to hold the non-adhesive strip material 178, on one side of strips 164, in an appropriate pattern for application to the surface surrounding a wound or other damage to be dressed or mended. The adhesive side of strips 164, wound surface adhesive layer 180, may be used to hold protective layer 182 in place. Protective layer 182 may be made of any convenient material such as a coated paper or plastic having a controlled level of adhesion to wound surface adhesion layer 182. Protective layer 182 serves to protect and maintain the adhesive strength of wound surface adhesive layer 180 before application of the strips to the wound or other damage to be dressed or mended and serves to maintain some level of sterility for strips 164 before they are used. However, in most if not all medical applications, applicator 154 would likely be contained in a sealed package to maintain sterility before use. In any event, protective layer 182 would typically be removed, or peeled away, just before use of applicator 156.

The relative adhesion strengths of the various layers are critical for most effective use of applicator 156. For example, the strength of adhesion between protective layer 182 and wound surface adhesion layer 180 must be sufficient to maintain protective layer 182 in place before use. However, the strength of adhesion between layers 180 and 182 must be sufficiently low so that protective layer 182 may easily be removed by hand without disturbing the adhesion of strips 164 to strip top adhesive layer 176.

Further, the strength of adhesion between strip top adhesive layer 176 and strips 164 must be sufficiently lower than the strength of adhesion between wound surface adhesion layer 180 when strip or strips 164 are applied to the wound so that further rotation of roller assembly 156 causes strips 164, which are adhered to the wound, to pull off from strip top adhesive layer 176 without substantial distortion of the strips or of the direction of rolling of roller assembly 156.

A surface coating on the side of protective layer 182 adhered to applicator 156 may be used to control the relative adhesion strength between wound surface adhesion layer 180 and protective layer 182. The adhesion strength between wound surface adhesive layer 180 and the protective layer 182 may be sufficiently smaller than between strip top adhesive layer 176 and strip material 178 so that removal of protective layer 176 does not substantially disturb the field of strips 174 releasably mounted on roller assembly 156. Further, the surface coating on protective layer 182 should not contaminate wound surface adhesion layer 180 or reduce the desired strength of adhesion between strips 164 and the surface to be dressed or mended.

Alternately, little or no adhesion between protective layer 182 and wound surface adhesion layer 180 may be required if protective layer is removeably held in place on applicator 154 by other means, such as by adhesion directly with strip top adhesive layer 176 at some parts of the surface of roller assembly 156 or by being secured to itself surrounding the surface of roller assembly 156 or by other means such as being held in place by frame handle assembly 158.

The remaining adhesion layers, such as adhesion layer 168 mounting compressible core layer 172 to roller assembly 156, must provide sufficient adhesion so that the remaining field of strips 164 on roller assembly 156 may be applied to the surface to be treated after one of more such strips have already be applied and removed from roller assembly 156.

The configuration described above with respect to roller assembly 156 of applicator 154 may advantageously be used for backing rollers of all designs and configurations including those disclosed herein. Suitable modifications may be appropriate for use with applicators in which the backing rollers are not cylinders, such as those described with reference to FIGS. 5, 6, 7, 8 and 13, to accommodate the differences in the shapes of those backing rollers or their equivalents.

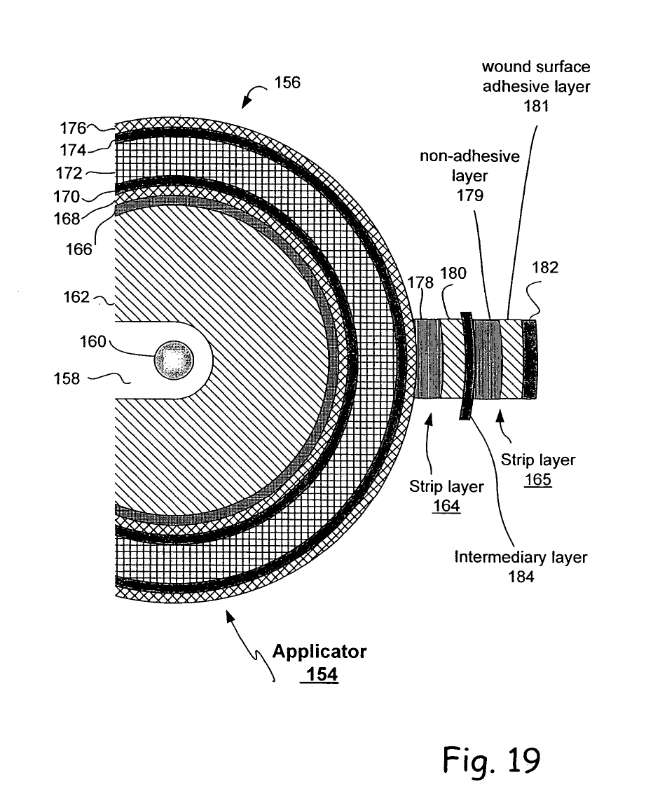

Referring now to FIG. 19, in some instances it may be desirable to have multiple layers of adhesive surgical strips, such as layers 164 and 165, for use perhaps in emergency kits. Innermost layer of strips 164 is adhered to adhesive layer 176. Intermediary layer 184, similar to protective layer 182, may be held in place by wound surface adhesive layer 180 of strip layer 164 while itself holding non-adhesive layer 179 of strip layer 165 in place. Protective layer 182 may then be held in place by wound adhesive layer 181.

Before use, protective layer 182 is removed without disturbing strip layers 164 or 165 or intermediate layer 184. The adhesive strength between protective layer 182 and strip layer 165 must therefore be lower than the adhesion strengths of the various other layers discussed below. The adhesion of wound surface adhesion layer 181 to the wound to be dressed must be relatively strong, so the adhesion strength between wound surface adhesion layer 181 and protective layer 182 may conveniently be reduced or controlled by the use of a slick surface on the side of protective layer 182 adjacent wound surface adhesion layer 181. The adhesion of wound surface adhesion layer 181 to the wound to be dressed must be stronger than the adhesion between non-adhesive layer 179 of strip 165 and intermediary layer 184 so that strips 165 may be cleanly detached from intermediary layer 184 when adhered to the wound to be dressed.

Intermediary layer 184 conveniently serves as a protective layer for strip layer 164 until used. The adhesion strength of intermediary layer 184 must therefore be less than the adhesion strength of strip layer 164 to strip top adhesive layer 176.

Those of ordinary skill in the art will recognize that the holder upon which the adhesive strips or bandages are carried need only be made of such material or coated with a layer of material such that the co-efficient of adhesion between the adhesive surface of the adhesive 10 strip or the adhesive area of the bandage is less than the co-efficient of adhesion between the adhesive and the skin surrounding the wound to which the sterile strips or bandages are to be applied. Likewise, the co-efficient of adhesion between the, for example, non-stick layer 30 and the adhesive surface of the surgical tape strip 14 is considerably less than the adhesive forces between the surface of the roll 12, for example, and the non-adhesive surface of the surgical tape strip 14. These are all matters within the ordinary skill of workers in the art and those of ordinary skill in the art will recognize that 3M Company markets sterile strips having the unique properties that are applicable to the present invention under the trademark Steri-Strip®. A suitable adhesive strip and materials that may be also used are those disclosed in U.S. Pat. No. 3,645,835 entitled MOISTURE-VAPOR-PERMEABLE PRESSURE 20 SENSITIVE ADHESIVE MATERIALS, the disclosure of which is hereby incorporated by reference. The same parameters apply to bandages having cotton or gauze areas.

While the invention has been described with respect to surgical adhesive tape strips or bandages of a certain size it should be recognized that various widths and lengths are contemplated and that the holder whether it be a platen, substrate or roll may be modified accordingly so as to adapt to the configuration of the strips or bandages contemplated.

Additionally, the holder for the strips or bandages may be of various shapes, configurations and materials whether they be made of foam, rubber, gel, etc., and all such matters are within the ordinary skill of workers in the art and need not be delved into herein, it only being important that the adhesive qualities of holder or applicator and surgical tape be kept in mind so as to have an easy application of the spaced surgical tape segments to the wound to be closed.

Further as is contemplated in the health field, the devices of the invention are intended to be disposable for one time use only and therefore would be individually packaged not only to have sterility but also to provide ease of access, ease of use and ease of discarding.

However, also contemplated are sterilizable and reusable holders in which case the materials of construction should likewise be compatible.

Additionally, the strips or bandages may take the form of sheets should it be so desired wherein the sheets or bandages may be on various sizes and discontinuous in places in order to allow air to be accessible to the surgical wound area to which the same is applied. Gauze or cotton layered areas may also be used.

The sterile packaging, whether it be in plastic or otherwise, and the means of sterilization of the devices of the invention are all within the purview of those of ordinary skill in the art and need not be delved into herein.

Various modifications and alterations will at once present themselves to those of ordinary skill in the art and all such changes and modifications are intended to be covered by the appended claims.

1. A medical appliance for dressing wounds, comprising:
an adhesive strip adapted to be applied to a wound area as a dressing or bandage; and
a backing plate on which the adhesive strip is adhesively mounted;
wherein the strength of adhesive between the adhesive strip and the backing plate is sufficiently less than the strength of adhesive between the adhesive strip and the wound area when the strip is adhered to the wound area to permit the backing plate to be removed after the strips are adhered to the wound area.

2. The invention of claim 1, further comprising:
a plurality of adhesive strips mounted to the backing plate in a pattern so that the strips may be adhered to the wound area in a predetermined pattern.

3. The invention of claim 1 further comprising:
a relatively flat mounting surface on the backing plate on which said adhesive strip is mounted; and
a handle affixed to the backing plate for applying the adhesive strip to the wound by moving the mounting surface into contact with the wound and for removing the mounting surface from the adhesive strips when the strips are adhered to the wound area.

4. The invention of claim 1 further comprising:
a mounting surface on the backing plate curved about an axis, the adhesive strip mounted to said mounting surface; and
a handle affixed to the backing plate for applying the adhesive strip to the wound area, the handle adapted to move the mounting surface into contact with the wound area while causing the baking plate to rotate and press the adhesive strip against the wound area.

5. The invention of claim 4 wherein the adhesive strip is adhered to the mounting surface parallel with said axis.

6. The invention of claim 4 wherein the adhesive strip is adhered to the mounting surface transverse to said axis.

7. The invention of claims 5 or 6 wherein the adhesive strip comprises:
a plurality of adhesive strips mounted to the backing plate in a fixed pattern to produce a desired pattern of strips adhesively applied to the wound area.

8. The invention of claim 4 wherein the backing plate further comprises:
a generally cylindrical mounting surface mounted for rotation about said axis.

9. The invention of claim 8 further comprising:
an axle supporting the backing plate and mounted to said handle for rotation about said axis.

10. The invention of claim 8 wherein the generally cylindrical mounting surface further comprises:
a pair of sub-surfaces longitudinally separable along said axis when said sub-surfaces are applied to said wound area; and
each end of said adhesive strip being mounted on a different subsurface, said adhesive strip having elastic qualities between the ends thereof so that longitudinal separation of the sub-surfaces before application thereof to the wound area causes the adhesive strip to be in tension after being adhered to the wound area to help maintain closure of the wound.

11. The invention of claim 10 further comprising:
a plurality of additional adhesive strips adhered to the backing plate in a fixed pattern to produce a desired pattern of strips adhered to the wound area.

12. The invention of claim 9 wherein the handle further comprises:
a single arm supporting one end of the axle at one end of said arm;
a hand grip; and
on offset portion between said one end of said arm and said hand grip to cause pressure applied by the hand grip to be applied evenly across the wound.

13. The invention of claim 9 wherein said handle further comprises:
a pair of arms each supporting one end of the axle.

14. The invention of claim 8 wherein the handle further comprises:
an axle supporting the backing plate and adapted to be gripped at each of two ends for rotation of said mounting surface about said axis.

15. The invention of claim 8 further comprising:
a compressible layer mounted between the backing plate and the mounting surface.

16. The invention of claims 10, 12, 13, 14 or 15 wherein the generally cylindrical mounting surface further comprises:
a generally cylindrical mounting surface having a shape selected from the group of a convex surface, a concave surface and a cylindrical shape having one cross sectional end thereof substantially larger than another cross sectional end thereof.

17. A method for adhering strips to a wound area, comprising:
adhesively applying a first surface of an adhesive strip to a backing plate with a first strength of adhesion;
adhesively applying a second surface of the adhesive strip to the wound area with a second strength of adhesion greater than said first strength of adhesion; and
removing the backing plate from the wound area, leaving the adhesive strip adhered to the wound area.

18. The invention of claim 17, further comprising:
adhesively applying the first surfaces of a plurality of adhesive strips to the backing plate with the first strength of adhesion;
adhesively applying the second surfaces of the plurality of adhesive strips to the wound area with the second strength of adhesion to produce a desired pattern of strips adhesively applied to the wound area when the backing plate is removed from the wound area.

19. The invention of claim 18 wherein adhesively applying the second surfaces of the plurality of adhesive strips to the wound area further comprises:
pressing the second surfaces of the adhesive strips against the wound area with a handle attached to the backing plate; and then
pulling the backing plate away from the wound area with the handle to leave a pattern of the adhesive strips adhered to the wound area.

20. The invention of claim 18 wherein adhesively applying the second surfaces of the plurality of adhesive strips to the wound area further comprises:
rolling the backing plate about an axis while the second surfaces are in contact with the wound area.

21. The invention of claim 18 wherein adhesively applying the second surfaces of the plurality of adhesive strips to the wound area further comprises:
rotating the backing plate about an axis while the second surfaces are in contact with the wound area.

22. The invention of claims 20 or 21 wherein the adhesive strips are mounted to the backing plate in parallel with said axis.

23. The invention of claims 20 or 21 wherein the adhesive strips are mounted to the backing plate transverse to said axis.

24. The invention of claim 21 wherein the backing plate is generally cylindrical, the invention further comprising:
mounting the generally cylindrical backing plate rotation about said axis.

25. The invention of claim 24 wherein mounting the generally cylindrical backing further comprises:
mounting the generally cylindrical backing on an axle supported in a handle.

26. The invention of claim 25 wherein mounting the generally cylindrical backing plate further comprises:
mounting portions of said generally cylindrical backing plate along said axis;
adhering each end of said adhesive strips to a different portion of said backing plate; and
separating said portions when said adhesive strips are applied to said wound area so that the adhesive strips are in tension after being adhered to the wound area to help maintain closure of the wound.

27. The invention of claim 25 wherein mounting the generally cylindrical backing plate further comprises:
supporting one end of the axle at one end of an arm separated from a hand grip on the handle by an offset portion to cause apply pressure applied by the hand grip to be applied evenly across the wound area.

28. The invention of claim 25 wherein mounting the generally cylindrical backing plate further comprises:
supporting each end of the axle at one end of a pair of arms attached to a handle.

29. The invention of claim 28 further comprising:
placing a compressible layer between the backing plate and the adhesive strips to compensate for uneven features of the surface of the wound area.

30. The invention of claims 24, 25, 26, 27, 28 or 29 wherein the generally cylindrical mounting surface further comprises:
a generally cylindrical mounting surface having a shape selected from the group of a convex surface, a concave surface and a cylindrical shape having one cross sectional end thereof substantially larger than another cross sectional end thereof.

31. A medical appliance for applying adhesive strips to wound area, comprising:
adhesive strips adapted to be applied to a wound area; and
backing plate means on which the adhesive strips are adhesively mounted with a strength of adhesive less than the strength of adhesive between the adhesive strip and the wound area, when the strips are adhered to the wound area, for adhering the strips to the wound area in a predetermined pattern.

32. The invention of claim 31 further comprising:
handle means, affixed to the backing plate,
for adhering the adhesive strips to the wound area by moving the backing plate into contact with the wound area, and then
for removing the backing plate from the adhesive strips.

33. The invention of claim 31 further comprising:
handle means for mounting the backing plate for rotation about an axis to press the adhesive strips against the wound area.

34. The invention of claim 33 wherein the adhesive strips are adhered to the backing plate parallel with said axis.

35. The invention of claim 33 wherein the adhesive strips are adhered to the backing plate transverse to said axis.

36. The invention of claim 33 wherein the backing plate means further comprises:
a generally cylindrical mounting surface to which the strips are adhered.

37. The invention of claim 36 wherein the generally cylindrical mounting surface further comprises:
means for applying tension to the adhesive strips before the strips are applied to said wound area to cause the adhesive strips to be in tension after being adhered to the wound area to help maintain closure of the wound.

38. The invention of claim 33 wherein the handle means further comprises:
offset portion means for applying pressure from the handle means evenly across the wound.

39. The invention of claim 33 further comprising:
compressible layer means mounted between the backing plate and the mounting surface.

40. The invention of claims 14, 36, 37, 38, or 39 wherein the generally cylindrical mounting surface further comprises:
means, having a shape selected from the group of a convex surface, a concave surface and a cylindrical shape having one cross sectional end thereof substantially larger than another cross sectional end thereof, for applying the strips even to a wound area having a non-flat surface.
